(19) United States
(12) Patent Application Publication
(10) Pub. No.: US 2023/0382766 A1
(43) Pub. Date: Nov. 30, 2023

(54) FLUID TREATMENT SYSTEM

(71) Applicant: Ecowater Systems LLC, Woodbury, MN (US)

(72) Inventors: Christopher James Fangman, Red Wing, MN (US); Marty Louis Sobeck, Lacrosse, MN (US); Ryan Jeffrey Boyd, Roseville, MN (US)

(21) Appl. No.: 18/321,226

(22) Filed: May 22, 2023

Related U.S. Application Data
(60) Provisional application No. 63/345,713, filed on May 25, 2022.

(51) Int. Cl. C02F 1/00; C02F 1/42

(52) U.S. Cl. CPC C02F 1/006; C02F 1/42

(57) ABSTRACT

A fluid treatment system and method of aligning and securing mechanical components within the system. The system comprises a container base with vertically extending sidewalls forming a sump, and a tank retainer disposed on the base within the sump. A system plate encapsulates the sump, and may include a bridge member projecting from the plate's top surface. A media bottle's bottom surface is placed within the tank retainer, and the media bottle's neck is received by an annular collar of the system plate such that the media bottle is secured within the system and movement of the media bottle within the sump is inhibited and/or restricted.

### BACKGROUND OF THE INVENTION

### 1. Field of the Invention

The present invention relates to a fluid treatment system, and more particularly to a water softening system having a regenerative mineral container for housing a resin media bottle/tank. The water treatment system is designed to treat hard water with a packed ion-exchange filter media.

### 2. Description of the Related Art

Fluid treatment systems, such as residential water softening systems, include a regenerative mineral container (called a “brine tank”), which is a sizable, largely empty sump may contain components such as a resin media tank/bottle, a brine well, valve assembly, and other mechanicals. Components of the fluid treatment system are typically fixed within the system in various locations. Unfortunately, these components are too often fixed inadequately within the system. Large, heavy components such as resin media bottles pose a particular issue when fixed improperly, as any shifting within the sump has a large potential to cause damage to the system, often causing cracking and breakages of the brine tank or cover systems. While this problem can be solved during shipping through the use of packaging media (e.g., packing peanuts, void fill, box lining, etc.) this is often costly, environmentally detrimental, and only prevents damage during shipping of the system. Prior to installation, these packaging materials must be removed, creating significant waste and increasing the time for installation of the fluid treatment system. Further, once packaging material is removed, the system is once again at risk to breakage should the system components shift during maintenance, repairs, or accidental or intentional movement of the system location. Thus, a need exists to create a fluid treatment system which can secure internal components within the sump for travel and inevitable jostling without the need for costly packaging solutions.

Further issues arise with these systems due to the entrapment of regenerative media such as softening salt pellets, softening salt crystals, and the like within the system components during filling/refilling operations. The brine well, for example, is a cylindrical barrier or tube that generally encompasses a valve assembly, allowing the operation of the assembly without any obstruction. Commonly, valve assemblies will be prone to failure if regenerative media is introduced within the brine well interior. Brine wells often include small, removable covers that are prone to removal and misplacement. In such scenarios, the addition of regenerative media may introduce extraneous, unwanted material into the brine well which may damage the system components. Thus, a need exists for a coverless brine well capable of restricting the introduction of regenerative media during fill/refill operations.

### SUMMARY OF THE INVENTION

Bearing in mind the problems and deficiencies of the prior art, it is therefore an object of the present invention to provide a fluid treatment system which secures the resin media bottle for travel, and does not require packing materials during shipping.

It is another object of the present invention to provide a fluid treatment system which is easy to install, and ensures proper alignment of the internal mechanicals.

A further object of the present invention is to provide a fluid treatment system which restricts movement of the mechanicals after installation.

It is another object of the present invention to provide a brine well system which prevents the introduction of regenerative media into the well/tube interior, and provides a tactile feedback during assembly when placed into proper alignment within the sump interior.

Yet another object of the present invention is to provide a brine well system capable of rejecting regenerative media during fill/refill operations in order to maintain a particle-free brine well system and valve system for premium operation throughout the life of the fluid treatment system.

Still other objects and advantages of the invention will in part be obvious and will in part be apparent from the specification.

The above and other objects, which will be apparent to those skilled in the art, are achieved in the present invention which is directed to a container for use with a fluid treatment system comprising a container housing comprising a base with vertically extending sidewalls forming a sump and a tank retainer disposed on the base within the sump said tank retainer comprising a tank platform and a plurality of raised circumferential sidewalls surrounding the tank platform and connected at a lower end to the tank platform. The tank retainer may be asymmetrically positioned about the base and adjacent one of said vertically extending sidewalls such that said tank retainer limits movement of a media bottle within the sump.

Tank retainer may be sized to receive a bottom end of a media bottle and comprise a convex structure complementary to the media bottle bottom end. The tank platform may include an opening and the bottom end of the media bottle may extend into a portion of the opening of the tank platform. The tank retainer may be constructed of a resilient material which would permit deformation and straightening of the tank retainer by a media bottle.

Each of the plurality of raised circumferential sidewalls may include an arched section extending between coping sections of the raised circumferential sidewall. Optionally, one of the plurality of raised circumferential sidewalls may extend from the base to a first height, H1, and another of the plurality of raised circumferential sidewalls may extend from the base to a second height, H2, not equal to H1.

The plurality of raised circumferential sidewalls may comprise a first raised sidewall extending from the base to a first height, H1, a second raised sidewall extending from the base to a second height, H2, and a third raised sidewall extending from the base to a third height, H3. Each of H1, H2, and H3 may be different heights.

The present invention also provides a system plate for use with a fluid treatment system, comprising a plate surface having a top side, a bottom side, and an outer wall extending from said bottom side. A plate aperture may extend through the plate surface, and may include a resilient annular collar which is terminated in a rounded lower wall. A bridge member may project from the plate surface top side, providing reinforcement to the tank plate. The rounded lower wall may be constructed of a resilient material such that the plate aperture is capable of deforming upon engagement with a media bottle neck. The system plate may include a well retention ring having a hollow channel, sized for couplable engagement with a brine well end. A slotted fitting or clip may be included on the well retention ring for couplable engagement with a slotted opening or track of the brine well end.

Further, the present invention also provides a fluid treatment system, comprising a container comprising a base with vertically extending sidewalls forming a sump, and a tank retainer disposed on the base within the sump. The tank retainer comprises a tank platform and a plurality of raised circumferential sidewalls surrounding and connected at a lower end to the tank platform. A system plate encapsulates the sump, including a top side having a bridge member projecting therefrom, a bottom side, and an outer wall extending from said bottom side. The system plate further comprises a resilient annular collar terminating in a rounded lower wall and having an aperture therethrough. A media bottle having a neck portion, a shoulder portion, and a bottom surface may be received by the tank retainer and the media bottle neck portion may be received by the annular collar such that the media bottle may be secured within the system at a substantial angle to the container base.

The system further comprises a brine well having a first end, a second end, and a length therebetween. The system plate comprises a well retention ring having a hollow channel, sized for couplable engagement with the brine well first end. The well retention ring further includes a slotted fitting or clip for couplable engagement with a slotted opening or track of the brine well first end. The container base may comprise a well locking assembly sized to receive the brine well second end, such that upon placement of the brine well second end within the well locking assembly, movement of the brine well within the sump portion is restricted. The well locking assembly may be located adjacent the tank retainer. The container may include a peripheral rim having a plurality of connection openings and/or locking protrusions for connection with a plurality of locking protrusions and/or connection openings of the plate outer wall.

The system may include a system cover encasing a portion of the system plate, comprising a fill funnel coupled to an outer circumference of the well retention ring. The fill funnel comprises a ramped top surface and a cavity extending within a portion of the fill funnel. The cavity including a lower surface comprising a discriminative well for permitting ingress of fluids to a brine well interior while restricting ingress of regenerative media to the brine well interior.

The present invention also provides a method of assembling a fluid treatment system. The method comprises providing a container comprising a base with vertically extending sidewalls forming a sump, and a tank retainer asymmetrically positioned about the base and within the sump. The tank retainer comprises a tank platform and a plurality of raised circumferential sidewalls surrounding the tank platform and connected at a lower end to the tank platform. The method comprises inserting a media bottle into the container sump and placing a bottom surface of the media bottle within the tank retainer, placing a system plate above the container sump, lowering the plate onto the sump such that a media bottle neck deforms a resilient annular collar of the system plate as the neck is moved through a system plate aperture. The method includes securing the system plate to the container such that the system plate encapsulates the sump and limits movement of the media bottle within the sump. The container may include a peripheral rim having a plurality of connection openings and/or locking protrusions for connection with a plurality of locking protrusions and/or connection openings of an outer wall of the system plate as the system plate is secured to the container, preventing movement of the system plate in a direction opposite the peripheral rim.

The method may further include shipping the fluid treatment system from a first location to a second location using a freight transporter. The method may also include placing a brine well having a lower end a well locking assembly disposed on the base within the sump, and securing an upper end of the brine well to a system plate alignment system such that the brine well is maintained at a substantial angle to the container base and movement of the brine well within the sump is limited. A system cover may be coupled to the system plate such that a fill funnel of the system plate is in communication with the brine well.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1A is a perspective view of the fluid treatment system according to an embodiment of the present invention;

FIG. 1B is a top plan view of the fluid treatment system according to FIG. 1A;

FIG. 2 is an exploded view of the fluid treatment system according to an embodiment of the present invention;

FIG. 3A is a cross-sectional view of the fluid treatment system according to an embodiment of the present invention;

FIG. 3B is a cross-sectional view of the fluid treatment system according to an embodiment of the present invention;

FIG. 4A is a cross-sectional view of the fluid treatment system according to an embodiment of the present invention, with interior mechanicals removed;

FIG. 4B is a cross-sectional view of the fluid treatment system according to an embodiment of the present invention, with interior mechanicals removed;

FIG. 5A is an enlarged perspective view of the fluid treatment system according to an embodiment of the present invention;

FIG. 5B is an enlarged, cross-sectional view of the fluid treatment system according to an embodiment of the present invention;

FIG. 6A is a bottom perspective view of the system plate and cover of the fluid treatment system according to an embodiment of the present invention;

FIG. 6B is a perspective view of the system plate of the fluid treatment system according to an embodiment of the present invention;

FIG. 7 is a top down view of a portion of the fluid treatment system according to an embodiment of the present invention;

FIG. 8 is an enlarged, sectional view of the fluid treatment system according to an embodiment of the present invention;

FIG. 9 is an enlarged, cross-sectional view of the fluid treatment system according to an embodiment of the present invention.

### DESCRIPTION OF THE EMBODIMENT(S)

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc., may be used herein to describe various components, these components should not be limited by these terms. These terms are only used to distinguish one component from another. For example, a first element could be termed a second element, and, similarly, a second element could be termed a first element, without departing from the scope of the present invention. As used herein, the singular forms “a”, an and “the” are intended to include the plural forms as well, unless the context clearly indicates otherwise. Also, as used herein, the term “and/or” includes any and all combinations of one or more of the associated listed items. It will be further understood that the terms “include” and/or “including” when used herein, specify the presence of stated features, steps, operations, elements, and/or components, but do not preclude the presence or addition of one or more other features, steps, operations, elements, components, and/or groups thereof.

Relative terms such as “below,” “above,” “upper,” “lower,” “horizontal,” “vertical,” “top,” “bottom,” “rear,” “front,” “side,” or the like may be used herein to describe a relationship of one element or component to another element or component as illustrated in the figures. It will be understood that these terms are intended to encompass different orientations of the device in addition to the orientation depicted in the figures.

Additionally, in the subject description, the words “exemplary,” “illustrative,” or the like are used to mean serving as an example, instance or illustration. Any aspect or design described herein as “exemplary” or “illustrative” is not necessarily intended to be construed as preferred or advantageous over other aspects or design. Rather, use of the words “exemplary” or “illustrative” is merely intended to present concepts in a concrete fashion.

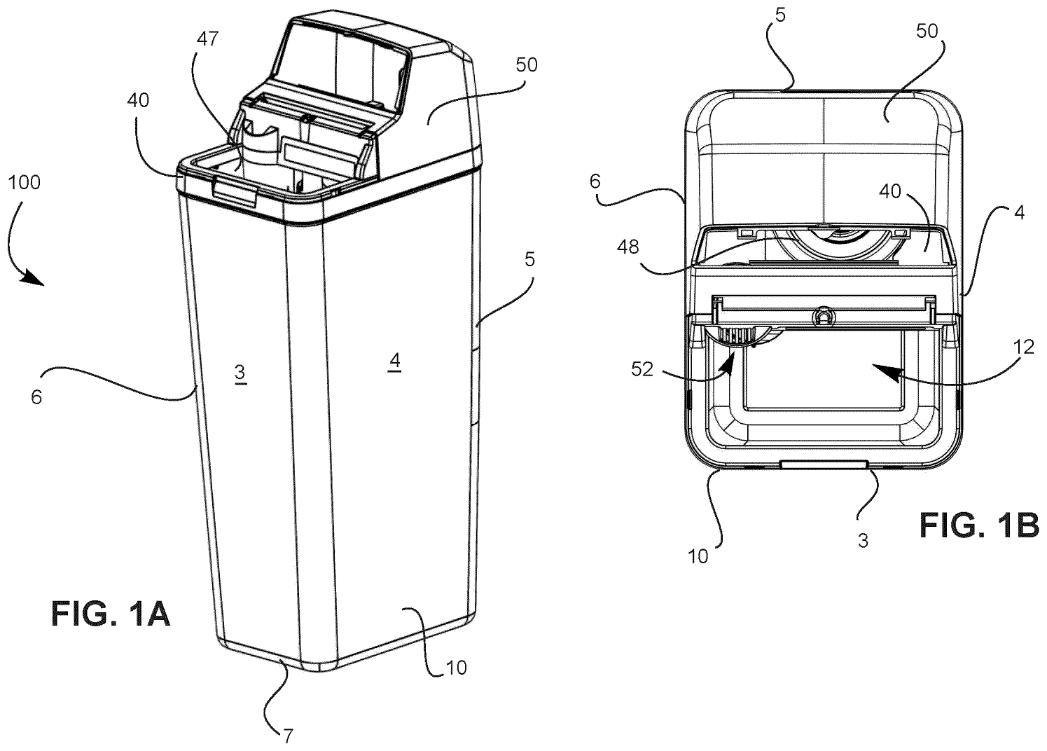

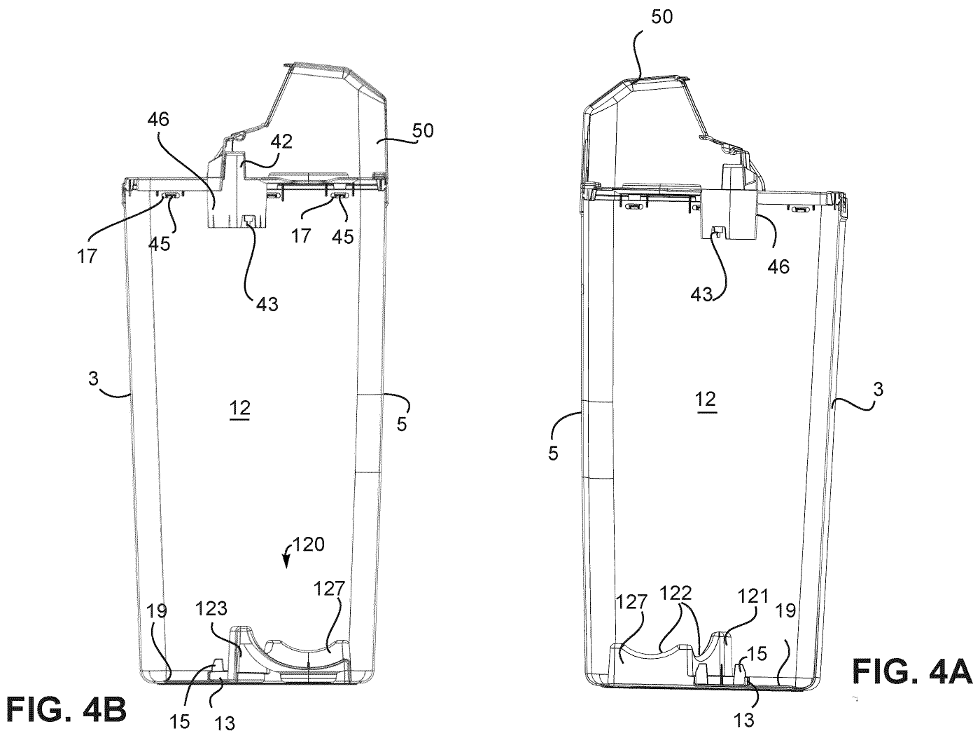

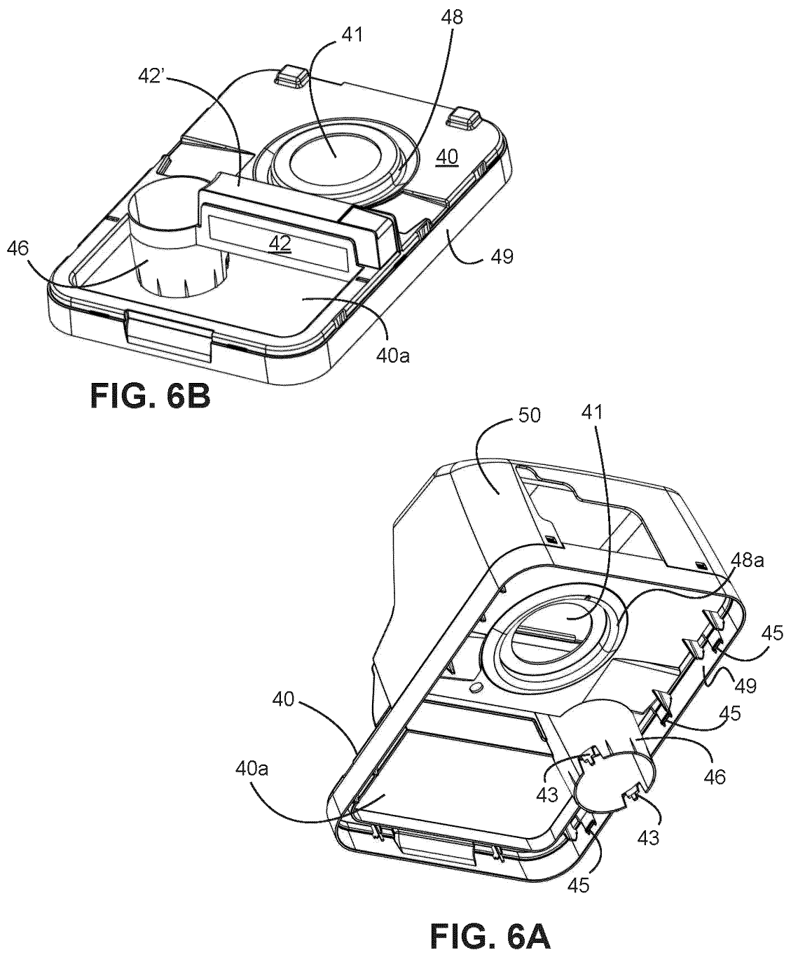

In describing the embodiment of the present invention, reference will be made herein to FIGS. 1-9 of the drawings in which like numerals refer to like features of the invention.

The present invention provides a fluid treatment system which secures a resin media bottle or tank for shipment without requiring packing material or packing fill during shipping. The fluid treatment system reduces installation complexities, and ensures alignment of the systems internal mechanicals such that movement of the mechanicals will be inhibited and/or restricted. The system may comprise a brine well system which prevents the introduction of regenerative media into the brine well interior, and may provide tactile feedback during assembly when placed into proper alignment within the system sump. The brine well system may reject regenerative media during fill/refill operations in order to maintain a particle-free brine well and valve assembly, ensuring premier performance of the system throughout the system's lifetime.

Referring to FIGS. 1-4, a fluid treatment system (shown generally at 100) is depicted including a regenerative mineral (RM) container 10. RM container is provided with side walls 3, 4, 5 and 6 extending from a base 7 and having an open upper end with a peripheral rim 9, discussed in detail below. An interior portion or sump 12 houses a brine well 30 and a media bottle/tank 20 therein. Media bottle 20 may comprise a resin media tank/bottle, a mineral tank/bottle, or the like which houses polystyrene media beads, such as resin, and/or zeolites. A system plate 40 may be secured to the RM container 10, encapsulating the container sump 12. Plate 40 may include an opening 47 for placement of regenerative mineral crystals and/or pellets consisting of sodium chloride, potassium chloride, and the like (not shown) within the container sump 12. Media bottle 20 may be secured to the system 100 by reception of the media bottle neck within plate aperture 41, which includes a resilient annular collar or gusset 48, discussed in further detail below. A brine well retention ring 46 may be disposed approximately between and adjacent to tank opening 47 and tank aperture 41, forming a hollow channel 44 which is positioned adjacent to and may be coupled to system cover 50 via the cover fill funnel 52, which is discussed in further detail below.

System plate 40 may further comprise a bridge member 42 extending between aperture 41 and opening 47. At least a portion of bridge member 42 includes an upstanding portion 42′ which may extend or project vertically from the top surface of plate 40. Advantageously, bridge member 42 may be designed to provide structural reinforcement to the system plate 40 once attached to the RM container 10, further increasing the rigidity of the system 100 to prevent damage thereto. System cover 50 encases at least a portion of system plate 40, and may be secured to the plate through locking tabs, fasteners, or the like.

In some embodiments, plate 40 may be secured to the RM container peripheral rim 9 through engagement of one or more locking protrusion(s) 45 within connection slots/opening(s) 17, preventing movement of the system plate in a direction opposite the peripheral rim once secured. Locking protrusions 45 may comprise a curved portion 45b on one end to facilitate placement of the system plate onto the container peripheral rim 9, and a flat portion 45a on an opposing end to prevent release of the locking protrusion within with connection slot/opening after system plate 40 has been secured to RM container 10.

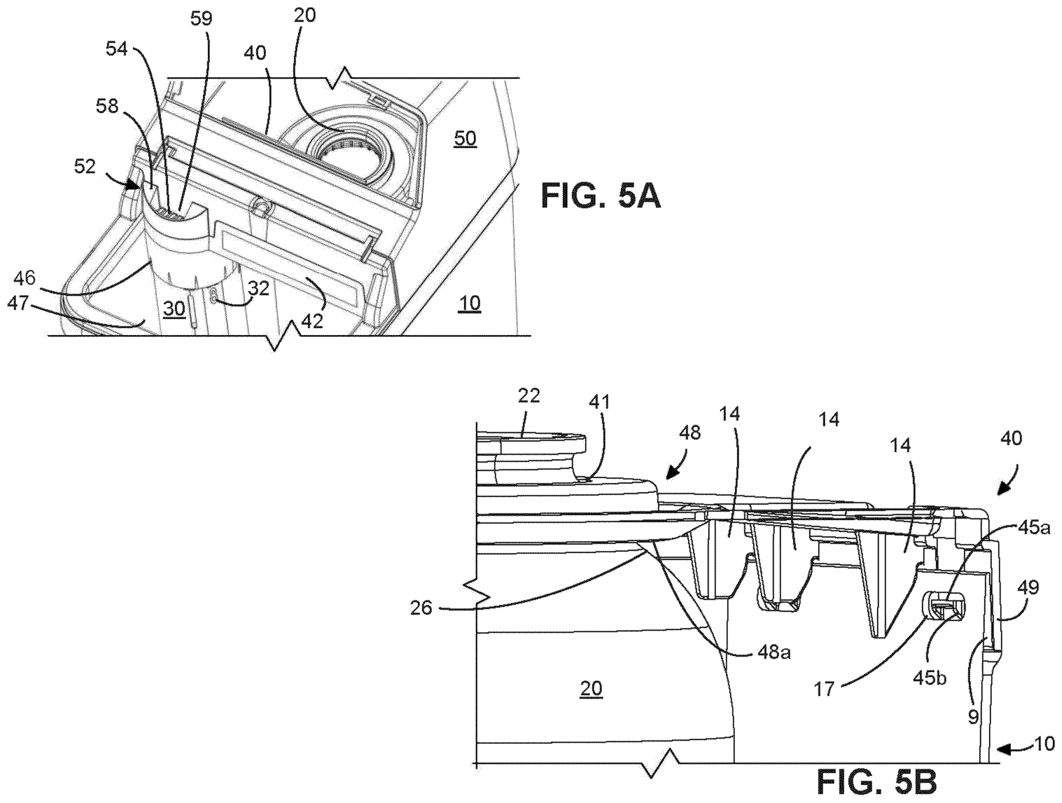

Though the illustrative view of FIG. 5B depicts locking protrusions 45a,b extending from the plate outer wall 49 towards the interior of system plate 40, other attachment schemes between locking protrusion 45a,b and connection slot/opening 17 are not meant to be precluded. In some embodiments, plate outer wall 49 may comprise one or more connection slots/openings for couplable engagement a locking protrusion on the container peripheral rim. In one or more embodiments, system plate 40 may comprise one or more alignment tabs 14 extending from interior of the system plate 40 adjacent the outer wall 49 to ensure proper connection between locking protrusion(s) 45a,b and the connection slot/opening(s) 17 as the system plate 40 is inserted onto the container peripheral rim 9.

In order to prevent media bottle/tank 20 from shifting during shipping and potentially breaking, cracking, or otherwise damaging system 100, the RM container bottom portion 19 includes a tank retainer 120, which may be integral to RM container 10 or may be a separate construction and secured to the sump bottom portion 19 via an adhesive, fasteners, or welded thereto.

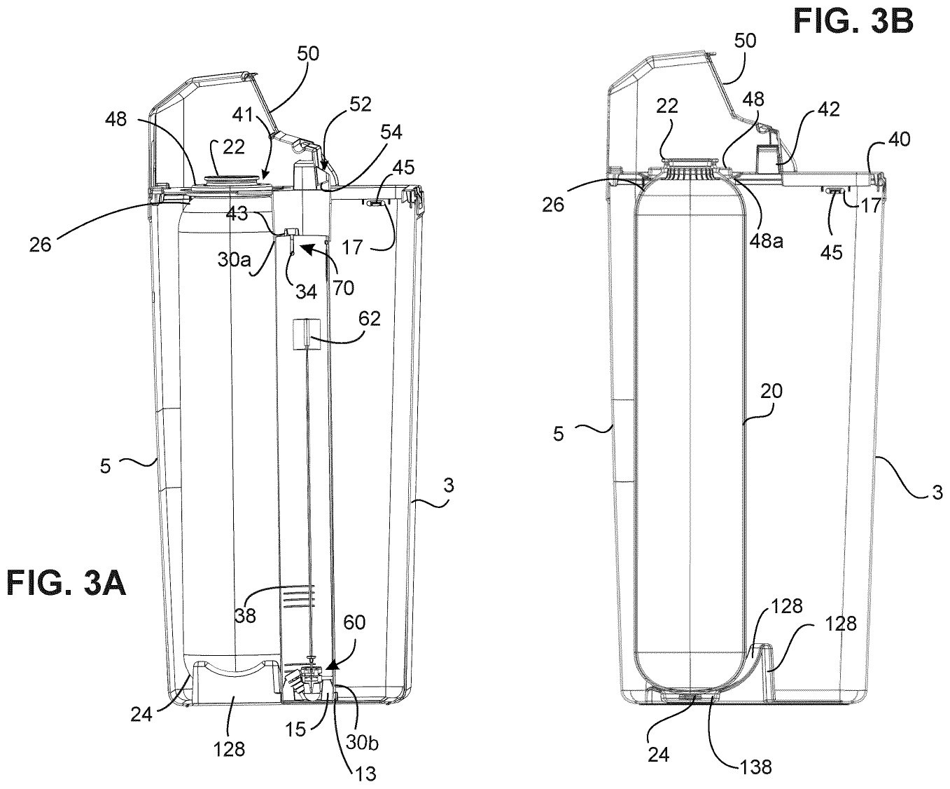

With reference to FIGS. 3A, 3B, 4A, 4B and 7-9, tank retainer 120 comprises one or more raised circumferential walls 121,123, 125, 127 that encircle a tank platform 130, with a bottom-most portion of tank platform 130 being attached to a bottom, interior edge of circumferential walls 121,123, 125, 127. Circumferential walls 121,123, 125, 127 of tank retainer 120 may form a curved, ramped, or partially hemispherical profile which may form a generally convex structure capable of receiving a spherical cap or other similarly shaped structure. Circumferential walls 121, 123, 125, 127 may include an arched section 122 between circumferential wall top surfaces or coping portions 128 which may further facilitate receipt of a media tank within tank retainer 120, while providing structural rigidity of the circumferential walls 121, 123, 125, 127. Tank platform 130 may additionally comprise a tank platform opening 138, which may be central platform 130.

After placement of the media bottle 20 within the basin formed by tank retainer 120, the media bottle bottom surface 24 will be located within the tank platform 130, and at least a portion of the media bottle's outer surface will be supported by one or more of the raised circumferential walls 121,123, 125, 127. Raised circumferential walls 121,123, 125, 127 may be any size necessary to structurally retain the media bottle 20, and may be any configuration necessary to retain media bottle 20 therein.

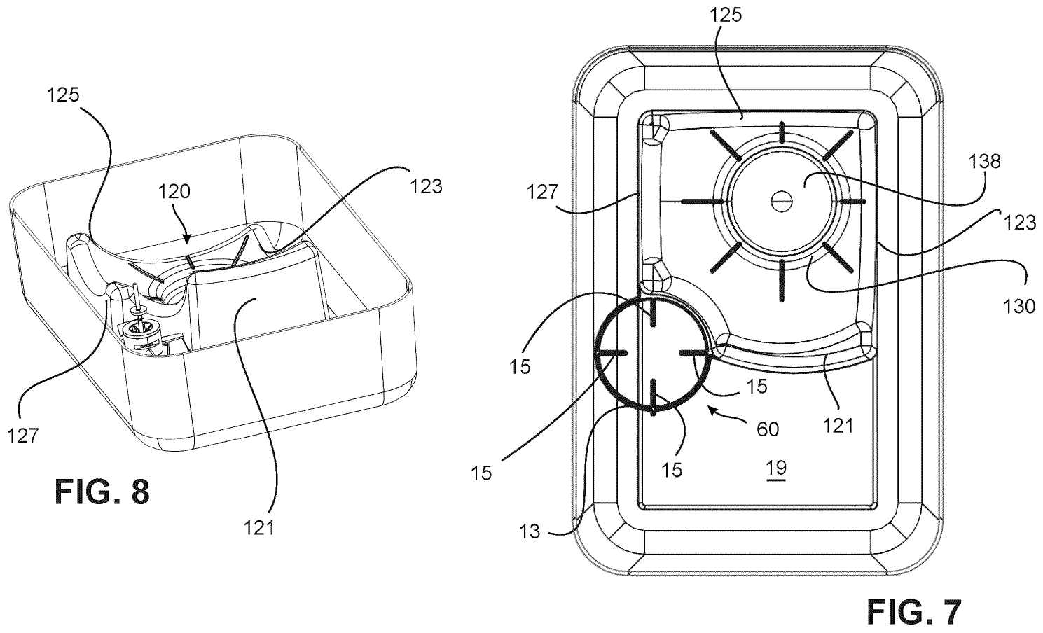

As shown in the exemplary view of FIG. 7, tank retainer 120 is positioned non-centrally or asymmetrically to container bottom portion 19. Advantageously, the asymmetrical positioning of tank retainer 120 will receive media bottle 20 such that one or more interior walls of the RM container (sidewalls 4 and 6 as depicted in FIG. 7) may provide further support to media bottle 20, thereby further limiting shifting and racking during movement of the system 100.

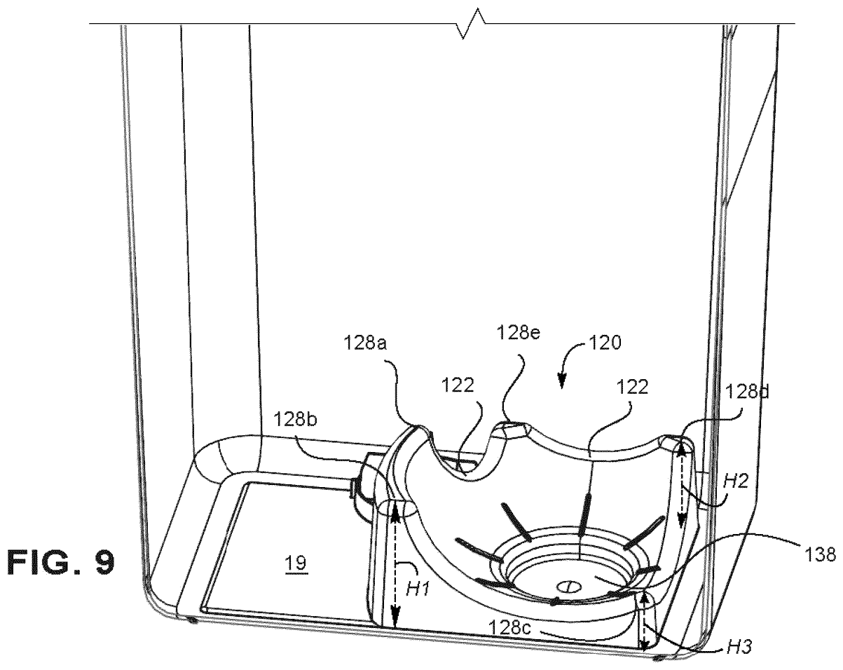

Referring to FIGS. 8 and 9, raised circumferential walls 121,123, 125, 127 may extend from the container bottom portion 19 to a plurality of heights, exemplarily shown as H1, H2, H3. Circumferential wall 125 is shown extending furthest from the container bottom portion 19 to H1, and is located proximate the center of the container bottom portion 19. When used in combination with the asymmetrically positioned tank retainer 120, the system 100 may reduce the maximum height necessary for the raised circumferential walls 121,123, 125, 127 to retain the media bottle 20 within sump 12. Such a configuration is optional, however, as tank retainer 120 can be located anywhere within the bottom surface 19, and may include any number of projecting raised circumferential walls having any height or various (multiple) heights to receive and secure media bottle 20 within the sump interior 12. Further, each of copings 128a-e may extend to the maximum height of the raised circumferential walls or may vary as necessary to provide safe and secure connection of the media bottle 20 within tank retainer 120 to prevent shifting of the media bottle which may damage the system 100.

In some embodiments, tank platform opening 138 may be used to receive a complementary structure from the media bottle 20, and may be of such a design that the media bottle 20 is keyed into the tank platform opening 138 to provide further structure and inhibit movement of the media bottle 20 within the RM container sump 12. As shown in FIGS. 3A and 3B, media bottle bottom surface 24 can be seen extending within at least a portion of the tank platform opening 138 to facilitate secure reception of the media bottle 20 within the tank retainer 120.

Turning now to FIG. 3A, the brine well end 30b may be held within a well locking assembly 60 comprising a circumferential projection 13, one or more flange extensions 15 for securing brine well 30 to the bottom surface 19 of the RM container. Flange extension(s) 15 may extend from the interior circumference of projection 13, and may extend radially toward the projection central interior. After the brine well end portion 30b is placed on top of projection 13 a positive stop is provided, facilitating proper alignment of brine well 30 through flange extension(s) 15. While flange extension(s) 15 are depicted as having a fin-shaped configuration, other shapes are not meant to be precluded, and a person of skill in the art would recognize that flange extension(s) 15 may have any configuration necessary to ensure the proper placement of the brine well 30 within the well locking assembly 60. Further, the well locking assembly 60 may be integral with the RM container bottom portion 19 or of a separate construction, and may be secured to the tank bottom by way of adhesive, spin welding, thermal welding, and the like.

The interior of brine well 30 includes valve assembly 62, as depicted in FIG. 3A, and may comprise a safety float, ball-and-valve, aircheck, and the like. The exterior of the brine well at end 30b may include a slot or opening 38, or a series of slots or openings thereof, for communication with the sump interior 12, and brine indicator 32 (see FIG. 5A), which may include marked graduations or some other indicia to let an end user know when additional regenerative minerals need to be added to the system. Upper end 30a of the brine well also includes a slotted opening or track 34 which may be received by a slotted fitting or clip 43 on the well retention ring 46 (alignment system 70 of FIG. 3A), to ensure proper localization and alignment of the brine well 30 within the sump interior 12 of the system 100. While the exemplary embodiments depicted show clip 43 received within the track 34 of the brine well, other connection modalities are not meant to be precluded, including a track and boss locking system, or any other detent mechanism which would be understood by a person of ordinary skill in the art. The alignment mechanism 70 described above is advantageous, as clip 43 and track 34 provide a couplable engagement to secure brine well 30 within the sump interior 12 without need for fasteners received in openings in the sides of the brine well, reducing any potential leakage within the brine well. In addition, the track and clip system include a positive stop, producing tactile feedback which indicates proper assembly of the brine well within the system plate and well retention ring 46.

After the brine well 30 has been placed within the well locking assembly 60 at the bottom end 30b and the alignment system 70 at the topside end 30a, movement of the brine well within the sump interior is restricted, and brine well 30 will be maintained at a substantial angle (e.g., approximately 90-degrees) with respect to container bottom portion 19 and also with respect to system plate 40. Advantageously, any potential displacement of the brine well as the system 100 is moved during shipping, storage, or installation is thereby limited. Thus, the well locking assembly 60 and alignment system 70 of the present invention provide ease of installation by eliminating the need for attachment of the brine well within the system via fasteners or gaskets, and ensure proper alignment of the brine well at all times.

Media bottle 20 may be secured to the system 100 at the lower end 24 via tank retainer 120. In some embodiments, media tank 20 may be further secured to the system by receiving tank neck 22 within plate aperture 41. As shown in FIGS. 3A and 3B, a resilient annular collar 48 surrounds aperture 41, terminating in lower wall 48a, resulting in a rounded, U-shaped cross-sectional. As illustrated, neck 22 may be received within aperture 41, such that lower wall 48a may circumferentially engage shoulder portion 26 of the media bottle 20. Thus, once placed within the system 100, media bottle 20 may be coupled to system plate 40, which may be connected to RM container 10, securing the media tank upper portion (i.e., neck 22 and shoulder portion 26) at a substantial angle (e.g., approximately 90-degrees) with respect to system plate 40. When used in combination with tank retainer 120, media tank bottle 20 will be engage within the system 100 at the lower and upper portion of the media bottle/tank 20, forming an engagement structure which may ensure proper placement/alignment of media bottle 20 at all times. Thus, the media tank upper portion and lower portion may be secured at a substantial angle (e.g., approximately 90-degrees) to both the bottom surface and system plate.

In addition, tank retainer 120 and tank collar 40 may be constructed of a resilient material which would allow for deforming, flexing, bowing, bending, and the like of the structure during engagement with media bottle/tank 20. Such a construction may be particularly advantageous when shipping the system 100, as media bottle 20 is the most prone to movement during this time. Due to the pliant nature of retainer 120 and collar 40 impact forces on the system interior due to the shifting of the media bottle may be absorbed or otherwise distributed as retainer 120 and collar 40 may deform as the media bottle is shifted within the system before returning to its previous, undeformed structure. Thus, media bottle 20 will be secured during transit of the system 100, limiting shifting or sliding of the media bottle which may cause damage to RM container 10, system plate 40, brine well 30, or any other components which may be prone to damage.

Due to the features of the tank retainer and tank collar of the system of the present invention, the system may accommodate, center, and/or secure a plurality of media tank diameters within the sump. Thus, a media bottle of a particular diameter which is housed within the system may be replaced by a media bottle of a smaller or larger diameter interchangeably, reducing waste and expense to consumers.

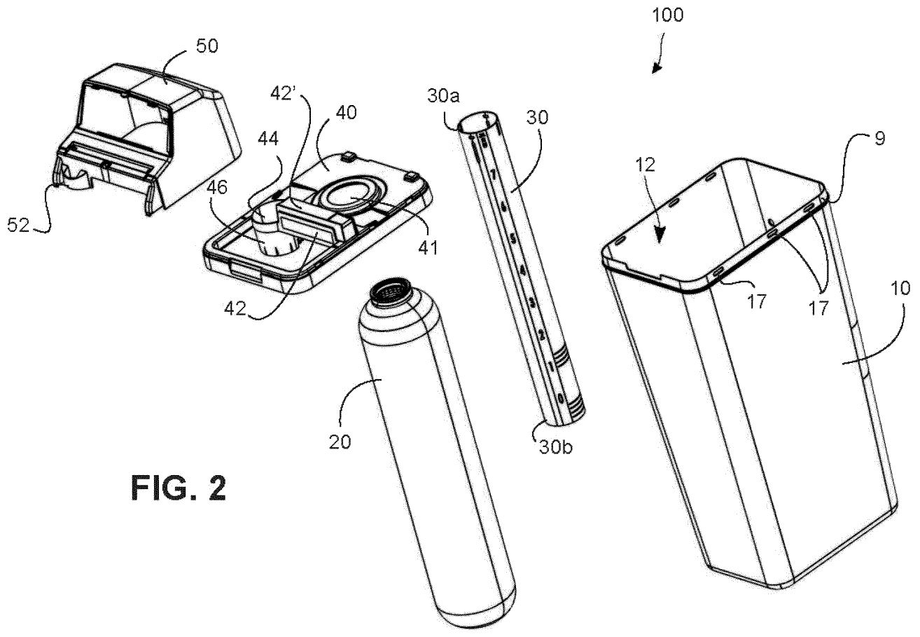

Turning now to FIGS. 2, 3A and 5A, an embodiment of the present invention utilizing a fill funnel on the system cover 50 is shown. System cover 50 may include an arcuate projecting section forming fill funnel 52, which may be coupled to the outer circumference of the well retention ring 46. A ramped top surface 58 covers at least a portion of brine well 30 so as to prevent regenerative minerals from entering the interior of brine well 30 during filling/refilling operations. Fill funnel 52 comprises top surface 58 which may be sloped towards plate opening 47, which may deflect regenerative minerals towards plate opening 47 during filling/refilling operations. Cavity 59 may be disposed on top surface 58 and extend through at least a portion thereof. The lower cavity may comprise a discriminative well 54 formed by a plurality of cutouts which may be slots, perforations, openings, and the like formed within the lower surface of cavity 59. Discriminative well 54 permits ingress of fluids to the brine well interior, while restricting or preventing ingress of regenerative media. Thus, servicing fluids may be added to the brine well interior to ensure proper system maintenance, while regenerative minerals will be captured within the discriminative well 54 during refilling/filling operations for subsequent retrieval. Advantageously, the interior of brine well 30 may remain unencumbered by regenerative minerals which may cause malfunction of the valve assembly. In some embodiments, discriminative well 54 may be sloped or pitched at an angle to facilitate proper addition of the servicing fluids, preventing large amounts of fluids from catching on the interior walls of the brine well 30 during maintenance operations.

During a method of assembly, which may be prior to shipment of the system 100, media bottle 20 will be placed above RM container 10 and lowered into sump 12 such that the media bottle bottom surface 24 is placed within tank retainer 120. Brine well lower end 30b may then be placed within the well locking assembly 60 to secure the brine well 30 (and valve assembly 62 within the brine well interior) within sump 12. After receipt of brine well 30 within well locking assembly 60 and media bottle/tank 20 within tank retainer 120, brine well 30 and media bottle 20 will be maintained at a substantial angle (e.g., 90-degrees) with the container bottom portion 19. System plate 40 may subsequently be placed over the container sump 12 and lowered. As plate 40 is lowered, tank neck 22 may deform the resilient annular collar 48 as tank neck 22 is moved from through aperture 41.

Similarly, lowering of plate 40 to the container peripheral rim 9 may cause brine well upper end 30a to engage alignment system 70 such that slotted opening or track 34 will be received by the slotted fitting or clip 43 on the well retention ring 46. In some embodiments, the track and clip system include a positive stop which produces tactile feedback indicating proper assembly of the brine well within the system plate.

Upon receipt of the system plate 40 with the container peripheral rim 9, locking protrusion(s) 45 may engage with connection slot/opening(s) 17. After final placement of system plate 40, brine well 30 and media bottle 20 may be secured within the sump 12, limiting further movement of the system 100. System cover 50 may be aligned and coupled to the system plate 40, placing fill funnel 52 in communication with plate channel 44. The exterior of system 100 may be packaged appropriately to prepare the system for system, such as by boxing, shrink wrap, and the like. Once transported to the installation location via a freight transporter such as an automobile, train, aircraft, marine craft and the like, system 100 may be unpacked and installed without need to remove packing material from the sump interior, as the system mechanical components will remain sufficiently secured and aligned within the sump during transit through the features of the fluid treatment system of the present invention.

Thus, the present invention provides one or more of the following advantages: a fluid treatment system which may be shipped without need for packing material/packing fill; a fluid treatment system which reduces installation complexities, and ensures alignment of the systems internal mechanicals; a brine well system which prevents the introduction of regenerative media into the brine well interior, and provides tactile feedback during assembly; a brine well system capable of rejecting regenerative media during fill/refill operations to ensure premier performance of the system throughout the system's lifetime.

While the present invention has been particularly described, in conjunction with one or more specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A container for use with a fluid treatment system, comprising:
a container housing comprising a base with vertically extending sidewalls forming a sump; and
a tank retainer disposed on the base within the sump said tank retainer comprising a tank platform and a plurality of raised circumferential sidewalls surrounding the tank platform and connected at a lower end to the tank platform;
wherein said tank retainer is asymmetrically positioned about the base and adjacent one of said vertically extending sidewalls such that said tank retainer limits movement of a media bottle within the sump.

2. The container of claim 1, wherein said tank retainer is sized to receive a bottom end of a media bottle and comprises a convex structure complementary to the media bottle bottom end.

3. The container of claim 1, wherein the tank platform includes an opening and wherein the bottom end of the media bottle extends into a portion of the opening of the tank platform.

4. The container of claim 1, wherein each of the plurality of raised circumferential sidewalls further include an arched section extending between coping sections of the raised circumferential sidewall.

5. The container of claim 1, wherein one of the plurality of raised circumferential sidewalls extends from the base to a first height, H1, and wherein another of the plurality of raised circumferential sidewalls extends from the base to a second height, H2, where H1 is not equal to H2.

6. The container of claim 1, wherein the plurality of raised circumferential sidewalls comprises a first raised sidewall extending from the base to a first height, H1, a second raised sidewall extending from the base to a second height, H2, and a third raised sidewall extending from the base to a third height, H3, where H1, H2, and H3 are different heights.

7. The container of claim 1, wherein the tank retainer is constructed of a resilient material.

8. A system plate for use with a fluid treatment system, comprising:
a plate surface having a top side, a bottom side, and an outer wall extending from said bottom side;
a plate aperture extending through the plate surface, said aperture including a resilient annular collar, said annular collar terminating in a rounded lower wall;
a bridge member projecting from the plate surface top side, said bridge member providing reinforcement to the tank plate; and
wherein said rounded lower wall is constructed of a resilient material such that said plate aperture is capable of deforming upon engagement with a media bottle neck.

9. The system plate of claim 8, further including a well retention ring having a hollow channel, said well retention ring sized for couplable engagement with a brine well end.

10. The system plate of claim 9, wherein the well retention ring further includes a slotted fitting or clip for couplable engagement with a slotted opening or track of the brine well end.

11. A fluid treatment system, comprising:
a container comprising a base with vertically extending sidewalls forming a sump, and a tank retainer disposed on the base within the sump, said tank retainer comprising a tank platform and a plurality of raised circumferential sidewalls surrounding and connected at a lower end to the tank platform;
a system plate encapsulating said sump, the system plate comprising a top side including a bridge member projecting therefrom, a bottom side, and an outer wall extending from said bottom side, said system plate further comprising a resilient annular collar terminating in a rounded lower wall and having an aperture therethrough;
a media bottle having a neck portion, a shoulder portion, and a bottom surface;
wherein the media bottle bottom surface is received by the tank retainer and the media bottle neck portion is received by the annular collar such that the media bottle is secured within the system at a substantial angle to the container base.

12. The fluid treatment system of claim 11, wherein the system further comprises a brine well having a first end, a second end, and a length therebetween, and wherein the system plate comprises a well retention ring having a hollow channel, said well retention ring sized for couplable engagement with the brine well first end.

13. The system plate of claim 12, wherein the well retention ring further includes a slotted fitting or clip for couplable engagement with a slotted opening or track of the brine well first end.

14. The fluid treatment system of claim 12, further comprising a system cover encasing a portion of the system plate, said system cover comprising a fill funnel coupled to an outer circumference of the well retention ring.

15. The fluid treatment system of claim 14, wherein the fill funnel comprises a ramped top surface and a cavity extending within a portion of the fill funnel, said cavity including a lower surface comprising a discriminative well for permitting ingress of fluids to a brine well interior while restricting ingress of regenerative media to the brine well interior.

16. The fluid treatment system of claim 12, wherein the container base comprises a well locking assembly sized to receive the brine well second end and such that upon placement of the brine well second end within the well locking assembly, movement of the brine well within the sump portion is restricted.

17. The fluid treatment system of claim 16, wherein the well locking assembly is located adjacent the tank retainer.

18. The fluid treatment system of claim 11, wherein the container includes a peripheral rim having a plurality of connection openings and/or locking protrusions for connection with a plurality of locking protrusions and/or connection openings of the plate outer wall.

19. A method of assembling a fluid treatment system, comprising:
providing a container comprising a base with vertically extending sidewalls forming a sump, and a tank retainer asymmetrically positioned about the base and within the sump, said tank retainer comprising a tank platform and a plurality of raised circumferential sidewalls surrounding the tank platform and connected at a lower end to the tank platform;
inserting a media bottle into the container sump and placing a bottom surface of the media bottle within the tank retainer;
placing a system plate above the container sump;
lowering the plate onto the sump such that a media bottle neck deforms a resilient annular collar of the system plate as the neck is moved through a system plate aperture; and
securing the system plate to the container such that the system plate encapsulates the sump and limits movement of the media bottle within the sump.

20. The method of claim 19, further comprising the steps of:
shipping the fluid treatment system from a first location to a second location using a freight transporter.

21. The method of claim 19, further comprising the steps of:
placing a brine well having a lower end a well locking assembly disposed on the base within the sump; and
securing an upper end of the brine well to a system plate alignment system such that the brine well is maintained at a substantial angle to the container base and movement of the brine well within the sump is limited.

22. The method of claim 21, further comprising the steps of:
coupling a system cover to the system plate such that a fill funnel of the system plate is in communication with the brine well.

23. The method of claim 19, wherein the container comprises a peripheral rim having a plurality of connection openings and/or locking protrusions for connection with a plurality of locking protrusions and/or connection openings of an outer wall of the system plate as the system plate is secured to the container, preventing movement of the system plate in a direction opposite the peripheral rim.
